(19) United States
(12) Patent Application Publication
(10) Pub. No.: US 2008/0103835 A1
(43) Pub. Date: May 1, 2008

(54) Systems and methods for providing road insurance

(75) Inventors: Paul Thomas Corcoran, Washington, IL (US); Ulf Johan Lindqwister, Peoria, IL (US); Stephen John Pierz, Peoria, IL (US); Michael Irvin Cline, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/589,828

(22) Filed: Oct. 31, 2006

(51) Int. Cl. G06Q 40/00; G05B 19/418

(52) U.S. Cl. 705/4; 705/8

(57) ABSTRACT

Systems and methods are disclosed for providing road insurance for a road construction project. In one embodiment, a customer may request a first insurance coverage amount for a road in a road insurance management system. The road insurance management system may determine, based on one or more design requirements, a design score for the road, and determine, based on one or more build requirements, a build score for the road. The road insurance management system may further determine a road project score based on the design score and the build score. The road insurance management system may determine a road insurance premium based on the first insurance coverage amount and the road project score.

### TECHNICAL FIELD

The present disclosure relates generally to a system for providing insurance for road construction projects, and more particularly to providing and administering insurance based on one or more parameters, such as road design, road construction quality, and after-build road usage.

### BACKGROUND

Insurance is generally obtained to provide compensation to an insured if a specified event occurs. Common examples include auto, home, health, and life insurances. Each type of insurance typically provides compensation to the insured in the event of a predefined event, such as an accident or theft in the case of automobile insurance. To receive such benefits, the insured generally pays a premium to the entity providing the insurance. In most cases, the insurance premium is determined based on the probability that the event will occur and the compensation amount that will need to be provided if the event occurs.

Underwriting is the process of establishing insurability and premium levels that will economically and profitably transfer risk from a policyholder to an insurance company. In determining insurability and premium, insurance companies take into account such factors as profit goals, competition, legal restrictions and the costs associated with losses (claims costs), loss adjustment expenses (claim settlements), operational expenses (commission and brokerage fees), general administrative expenses, and the cost of capital.

Construction projects present a unique set of risks and exposures for insurance underwriting. One way to manage risks of construction projects is by assessing the quality of a builder's operations. For example, U.S. patent application Ser. No. 10/802,129, by Luhr, filed on Mar. 16, 2004, describes a system for assessing a builder on a variety of quality measures that relate to the overall risk for the builder. The risk may be expressed, for example, as a numerical score, a grade, or an assigned tier-level. To access risk, the disclosed system considers factors such as design quality, builder knowledge, communications systems, customer service, data tracking, prior and active claims, safety programs, and legal/contractual/insurance issues. The builder risk assessment system also considers information obtained from field inspections of the builder's construction sites to generate the risk assessment. The information may be obtained by questions and inspection checkpoints that are created based on characteristics of the builder's operations, such as size, type, and geographical location of the builder's construction projects. In this manner, the assessment may be customized and used to compare the builder's quality and risk relative to that of other builders.

While conventional systems, such as that disclosed in U.S. patent application Ser. No. 10/802,129, may provide some mechanism for assessing the quality of a builder's operation, they are not useful for accessing insurance risk for a construction project, such as a road construction project. Such insurance risks are difficult to assess because they may be affected by a large variety of factors. Therefore, there is a need to comprehensively assess risks and perform insurance transactions for construction projects, such as road construction projects.

### SUMMARY OF THE INVENTION

It is to be understood that both the foregoing general description and the following detailed description are exemplary and explanatory only and are not restrictive of the disclosure as claimed.

Systems and methods are disclosed for providing road insurance for a road construction project. In one embodiment, a customer may request a first insurance coverage amount for a road in a road insurance management system. The road insurance management system may determine, based on one or more design requirements, a design score for the road, and determine, based on one or more build requirements, a build score for the road. The road insurance management system may further determine a road project score based on the design score and the build score. The road insurance management system may determine a road insurance premium based on the first insurance coverage amount and the road project score.

### BRIEF DESCRIPTION OF THE DRAWINGS

The accompanying drawings, which are incorporated in and constitute a part of this specification, illustrate exemplary embodiments of the disclosure and together with the description, serve to explain the principles of the disclosure. In the drawings:

FIG. 1 is a block diagram of an exemplary road insurance management environment consistent with certain embodiments of the present disclosure;

FIG. 2A is a flow chart of exemplary steps to perform a road insurance transaction consistent with certain embodiments of the present disclosure; and

FIG. 2B is another flow chart of exemplary steps to complete a road insurance transaction consistent with certain embodiments of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

In this disclosure, a road construction project may refer to a process of designing, building, and/or maintaining a road. A road may be any type of way for the passage of vehicles, people, and animals, such as a highway or a unpaved path. Road insurance may refer to an insurance policy provided by an insurer to an insured entity which is responsible for managing or maintaining one or more roads. An insurance policy is a written contract defining an insurance plan, its coverage, exclusions, eligibility requirements, and all benefits and conditions that apply to entities insured under the plan.

In one embodiment, according to a road insurance policy, in return for consideration (e.g., a road insurance premium) an insurer agrees to indemnify the insured entity against specified damage, loss or liability arising from the occurrence of specified risks or to compensate the insured entity upon the occurrence of a specified event for a road construction project. Such specified events may include maintenance or reparation projects for roads, such as a maintenance project to fix potholes on a road.

An insured entity may be any type of entity that designs, constructs, maintains, or manages roads. For example, an insured entity may be an individual or a private organization such as a construction company. An insured entity may also be a government organization, such as a state highway and transportation department that is responsible for highway maintenance. An insurer may be any type of entity that underwrites a road insurance policy for an insured entity.

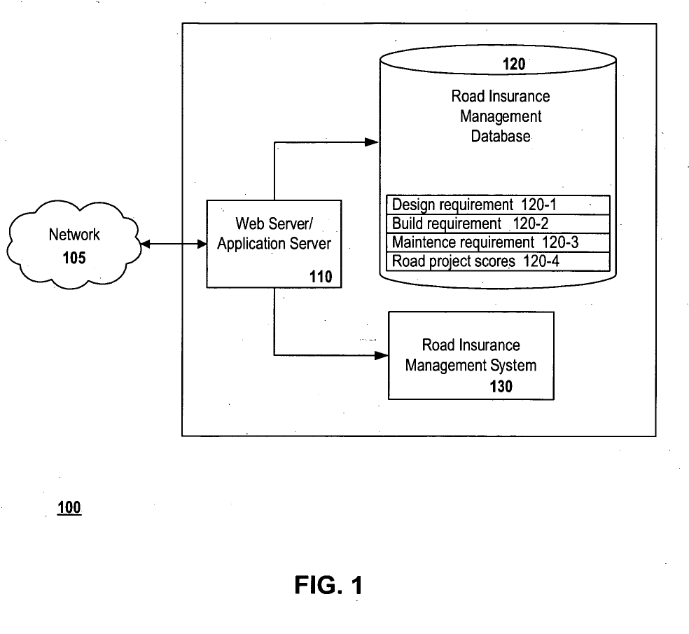

FIG. 1 illustrates an exemplary road insurance management environment 100. Road insurance management environment 100 may include a Web server/application server 110, a network 105, a road insurance management database 120, and a road insurance management system 130. Web server/application server 110 interfaces with network 105, road insurance management database 120, and road insurance management system 130. It is contemplated that road insurance management environment 100 may include some, all, or additional components illustrated in FIG. 1.

Network 105 may be any type of wireline or wireless communication network for exchanging or delivering information or signals, such as the Internet, a wireless local area network (LAN), or any other network. Thus, network 105 may be any type of communications system. For example, users and systems of road insurance management environment 100 may send or receive data using network 105.

Web server/application server 110 may implement any type of web server and/or application server software, such as Apache HTTP Server from the Apache Software Foundation. Web server/application server 110 may include an interface device (e.g., graphical user interface) for a user to access road insurance management database 120, and/or road insurance management system 130. A user of road insurance management environment 100 may enter data and request a road insurance premium quote using Web server/application server 110. A road insurance premium quote may refer to monthly, quarterly, or yearly, payments that need to be paid by an insured entity to obtain an insurance policy. A user of road insurance management environment 100 may be a representative of either an insurer or an insured entity.

Further, Web server/application server 110 may include additional software/hardware components, such as collaboration tools that permit users of road insurance management environment 100 to share data and information, to work together, bulletin boards to permit users to communicate with each other, and/or search engines to provide efficient access to specific entries in road insurance management database 120 or road insurance management system 130.

Road insurance management database 120 may be a system including hardware, firmware, and/or other software executed by a processor that is configured to store data records, charts, entries and changes made to the records, and other information used by users of road insurance management environment 100. Road insurance management database 120 may also include customer data and information related to insurance transactions for road insurance. Road insurance management database 120 may further include, actuarial tables, statistics, and other expert knowledge used to perform road insurance transactions consistent with certain disclosed embodiments.

Road insurance management database 120 may store data records related to one or more road construction projects. A road construction project may include, for example, a design phase, a build phase, and a maintenance phase. The design phase may include one or more business processes used to collect data and specify technical and functional standards for a road. Thus, in one embodiment, road insurance management database 120 may store a design requirement 120-1. A design requirement 120-1 may refer to any functional or technical metric a road may be designed to meet. For example, a design requirement for highway A may be its service life (e.g. service life of ten years).

The build phase may include all business processes and operations needed to construct a toad according to its design requirements. Road insurance management database 120 may also store a build requirement 120-2. A build requirement 120-2 may refer to a type of construction standard from which the road is constructed in order to meet design requirements 120-1. For example, to meet the design requirement 120-1 for a ten-year service life, one build requirement 120-2 may require the use of pavement material A. After the build phase, the road is complete and ready for use.

The maintenance phase may include the operations for any maintenance and reparation work performed after a road is in use. Road insurance management database 120 may also store a maintenance requirement 120-3. Maintenance requirement 120-3 may refer to any business or technical standard that may be implemented to maintain the road. For example, one maintenance requirement 120-3 may be that maintenance engineers need to complete scheduled seasonal road maintenance projects including patching potholes, sealing cracks and overlays. Road insurance management database 120 may include data records related to all phases of a road construction project, such as design requirement 120-1, build requirement 120-2, and maintenance requirement 120-3.

Road insurance management database 120 may further include a road project score 120-4. Road project score 120-4 may refer to a performance assessment of a road construction project with respect to design-requirement 120-1, build requirement 120-2, and maintenance requirement 120-3. Road project score 120-4 may be based on any type of quantitative value, such as one or more numeric values. For example, a construction expert may audit and inspect a road construction project and assess the project's performance when measured against design requirement 120-1, build requirement 120-2, and maintenance requirement 120-3. The construction expert may then use road insurance management system 130 to determine a road project score 120-4 based on the respective assessments. In one embodiment, road project score 120-4 may be assigned a value based on a range of predetermined values, with, for example, the lowest value indicating the worst assessment with respect to one or more requirements (e.g., 120-1, 120-2, and 120-3) and the highest value indicating the best assessment, relative to other values. Other ranges, criteria, and evaluation score indicators may also be implemented to determine road project score 120-4.

Road insurance system 130 may be a computer system or software executed by a processor that is configured to provide access to road insurance management records stored in road insurance management database 120. Road insurance management system 130 may receive an inquiry for a certain amount of insurance coverage from a user of road insurance management environment 100 through Web server/application server 110. Road insurance management system 130 may use the data in road insurance management database 120, such as road project score 120-4, actuarial tables, and other statistics to determine a road insurance premium, such as a premium requested by the user. Road insurance management system 130 may also provide data reflecting a determined insurance premium to the user through Web server/application server 110.

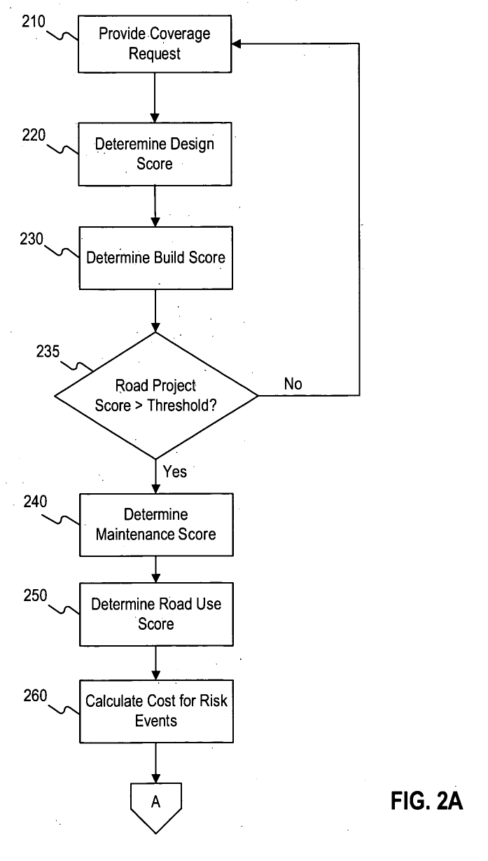

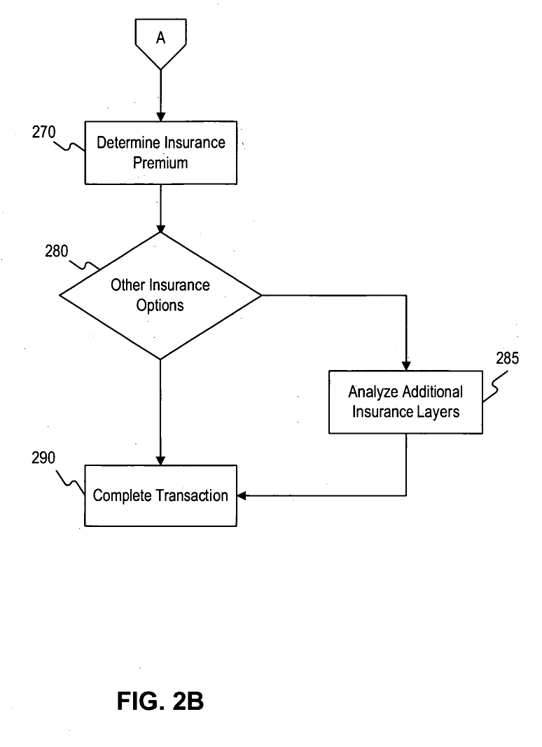

As explained above, road insurance management system 130 may perform a road insurance transaction upon request. FIGS. 2A and 2B illustrate a flow chart of exemplary steps for performing a road insurance transaction consistent with certain disclosed embodiments. As shown in FIG. 2A, a user of road insurance management environment 100 may provide a coverage request indicating a requested amount of insurance coverage for a road construction project to road insurance management system 130 (step 210). The amount of coverage may be previously determined based on typical coverage amounts for the industry, technology, known exposures to risks, etc. For example, a road construction company A may wish to obtain $50 million in insurance coverage for maintenance and reparation cost of highway A (e.g., 100 miles long, two lanes) for ten years after its completion. User A, who represents road construction company A, may submit the request to road insurance management system 130.

After receiving the amount of coverage requested, road insurance management system 130 may calculate the probability of potential claims against the insurance amount (e.g., the probability that a certain road reparation project and the related claim will occur). The probability that a claim will occur may be based on information in road insurance management databases 120 such as previously acquired expert knowledge (not shown), design requirement 120-1, build requirement 120-2, maintenance requirement 120-3, road project score 120-4, and/or other considerations (e.g., actuarial tables, statistics, etc.).

In one embodiment, to determine the probability of claims, an insurer may assign a construction expert to audit the road construction project and determine road project score 120-4 based on the audit results. Road insurance management system 130 may then calculate the probability for claims based on road project score 120-4.

First, the construction expert user may review each design requirement 120-1 for the road construction project, and assess whether a project meets or does not meet its design requirements 120-1 by accessing database 120. The construction expert may also compare design requirements 120-1 to one or more inquired insurance policy terms. The construction expert may provide this assessment to road insurance management system 130. Road insurance management system 130 may perform one or more processes (e.g., executes software to perform one or more algorithms) to calculate a design score for the road construction project based the on one or more expert assessments on how well the road construction project meets one or more design requirements 120-1 (step 220). For example, the construction expert may enter an assessment level with respect to one design requirement 120-1. Road management system 130 may then map the assessment value to a score value in a given range of values, such as a numerical value between 1 and 10. In one embodiment, a high design score may indicate that a road is designed to meet high quality and durability standards.

Referring back to the example of road construction company A and highway A, for example, a construction expert may review design requirements 120-1 of highway A to assess whether highway A was designed to have a service life of ten years (the requested insurance coverage time period). The construction experts may identify a set of design requirements 120-1 (e.g., base structure design, the choice of base materials, etc.) to assess the design of highway A. If the expert assessments with respect to design requirements 120-1 indicate that highway A is designed to meet its durability standard (i.e., is designed for a service life of ten or more years), road insurance management system 130 may assign highway A a high design score. Thus, an expert may provide one or more assessments related to design requirements 120-1.

The construction expert may also review each build requirement 120-2 related to the inquired road construction project in road insurance management system 130 to assess whether the project meets or does not meet one or more build requirements 120-2 (e.g., base material uniformity, pavement uniformity, etc.). The construction expert may provide the assessment to road insurance management system 130. Road insurance management system 130 may determine a build score for the road construction project based on the one or more expert assessments (e.g., executes software that performs one or more algorithms to generate a build score) (step 230). For example, the construction expert may provide a build assessment value, and road insurance management system. 130 may map this assessment value to a score value between a given range of values. In one embodiment, a high build score may indicate that a road is built to meet high quality and durability standards.

Referring back to the example of road construction company A and highway A, the construction expert may review whether highway A was built to have a service life of ten years. For example, to have over ten years of service life, one build requirement 120-2 may require that highway A is constructed using full-depth asphalt pavement. Accordingly, in this example, the construction expert may inspect whether the full length of highway A is built with full-depth asphalt pavement, and provide an assessment to road insurance management system 130. Road insurance management system 130 may assign the road a build score based on the one or more expert assessments.

Based on the assigned design score and build score for the road construction project, road insurance management system 130 may determine a road project score 120-4 (e.g., performing a scoring process, such as summing the design and build scores). Based on the road project score 120-4, road insurance management system 130 may determine whether the road can be insured (step 235). In one embodiment, a low road project score 120-4 may indicate that the road is assessed to have low design and/or build quality. Accordingly, when a road project score 120-4 is lower than a threshold value, road insurance management system 130 may determine that the road is not insurable, and present the decision to the user. Conversely, when the road project score 120-4 meets or exceeds the threshold value, road insurance management system 130 may proceed to further analyze the road construction project. Road insurance management system 130 may also present data to the user reflecting this decision.

Once the project score is analyzed and accepted, the maintenance and usage of the road is monitored and analyzed. If the road is already in service, a construction expert may further audit the records (e.g., invoices related to past road maintenance projects) for road maintenance performed in the past and monitor on-going and future maintenance projects. If the road has not been in service, the construction expert may audit the plans and procedures specified for road maintenance. The construction expert may review one or more maintenance requirements 120-2 stored in road insurance management system 120 to assess whether the road construction project meets the corresponding requirements. The construction expert may provide one or more assessments to road insurance management system 130. Road insurance management system 130 may determine a maintenance score for the road construction project based on the one or more assessments (step 240). For example, a well maintained road may receive a higher maintenance score than that of a road not as well maintained. The maintenance score may be incorporated into road project score 120-4.

Referring back to the example of road construction company A and highway A, the construction expert may audit and monitor the maintenance schedule and procedures for highway A. For example, if the expert assessments indicate that highway A is well maintained to meet a service life of ten or more years, road insurance management system 130 may assign highway A a high maintenance score (e.g., 7 out of 10). If the expert assessments indicate that highway A is well maintained to exceed a service life of ten or more years, road insurance management system 130 may assign highway A a higher maintenance score (e.g., 9 out of 10).

Further, during the service life of the road, the construction expert may periodically monitor the load for road use (e.g., truck traffic quantity, etc.) and the weather conditions (e.g., days of rain, extreme temperatures, etc.). If the road has not been in service yet, the construction expert may review information reflecting anticipated load for road use and weather conditions. The construction expert may assess how well the road will maintain its quality under the observed (or estimated) load of road use and weather damage. The construction expert may enter his assessments into road insurance management system 130. Road insurance management system 130 may determine a road usage score for the road construction project based on the one or more assessments (step 250). The road usage score may also be incorporated into road project score 120-4.

For instance, referring back-to the road construction example including company A and highway A, the construction expert may monitor the traffic load and weather condition for highway A. If the expert assessments indicate that highway A's road usage and weather damage is within its designed parameters, road insurance management system 130 may assign the road a relative high score for road usage.

Road insurance management system 130 may then recalculate the road project score 120-4 based on the design score, build score, maintenance score, and road usage score (e.g., summing the scores). Because road project score 120-4 reflects the design, build and maintenance quality of a road as well as the wear and tear of the road, it may be indicative of the risk of potential insurance claims. In one embodiment, road insurance management system 130 may use road project score 120-4 as the indicator for probability of claims.

Road insurance management system 130 may validate the road project score 120-4 by implementing a road condition monitoring system. A road condition monitoring system may be any type of system that collects data reflecting road conditions (surface smoothness, pavement structure problems, etc.) and/or uses the collected data to predict the performance of a road. A road condition monitoring system may be implemented by using one or more software/hardware components. A road condition monitoring system may collect data from the design, build, and maintenance phase of a road construction project, and calculate a road quality score (comparable to road project score 120-4) based on one or more road performance prediction algorithms. During the service life of a road, a road condition monitoring system may use road survey data to monitor road conditions and predict road performance in real time. For example, if actual traffic load of a road increases much beyond what the road was designed for, data reflecting such traffic load increase may be collected during a road survey and used to predict road performance. Road insurance management system 130 may validate the road project score 120-4 by checking that the score is consistent with the road condition monitoring system's calculations and predictions.

In one embodiment, the road condition monitoring system may utilize Three-Dimensional Finite Element Modeling (3DFEM) or simulations of pavement sections to predict road performance. The road condition monitoring system may monitor road conditions by collecting road survey data for a road. The road condition monitoring system may then enter the data collected during the road survey into a 3DFEM simulation program to predict the performance of the road. For example, the road condition monitoring system may collect and analyze data reflecting pavement cracking, falling weight deflectometer loading, truck loading, and thermal gradient on the structural response of pavement. The road condition monitoring system may calculate a road quality score B comparable to road project score 120-4 based on one or more defined algorithms. Road insurance management system 130 may validate that the road project score 120-4 is consistent with the road quality score B.

Referring back to FIG. 2A, after determining the road project score 120-4, road insurance management system 130 may calculate the cost of potential claims against the insurance amount (e.g., the cost to cover certain road reparation projects) (step 260). Road insurance management system 130 may take into account road project score 120-4, the cost of past and current road projects of a similar scale, any past and future income (e.g., tolls, etc.) from the road, related statistics and the like. In one embodiment, road insurance management system 130 may perform a valuation process that determines what information is needed regarding a road construction project to calculate the cost of potential claims. For example, a certain actuarial method may require that the construction expert collect specific financial data from a road construction project and enter the data in road insurance management system 130 for calculating the cost of potential claims. For instance, one type of relevant financial information may be various debts held by an insured entity. A high debt amount may indicate that the insured entity is a relatively high risk customer. Road insurance management system 130 may assume a higher interest rate (relative to the interested rate used for lower risk customers) when calculating the cost of potential claims for a high risk customer.

Referring back to the road construction example including company A and highway A, in one embodiment, road insurance management system 130 may assign a design score of 8 out of 10 to highway A, a build score of 9 out of 10, a maintenance score of 10 out of 10, and a road usage score of 9 out of 10. Road insurance management system 130 may then calculate road project score 120-4 for highway A by summing the scores. Thus, highway A may have a road project score 120-4 of 36 out of 40. Other methods may also be used to calculate the road project score 120-4. For example, a road project score 120-4 may be based on a weighted average of the design, build, maintenance, and road usage scores.

Road insurance management system 130 may use the road project score 120-4 and other expert information (e.g., actuarial tables, construction cost, etc.) stored in road insurance database 120 (or obtained elsewhere) to calculate the cost of potential claims. For example, based on statistics of comparable road maintenance projects cost, road insurance management system 130 may determine that the average cost of claims for similar road constructions projects is about $30 million measured in the net present value. Net present value measures the excess or shortfall of cash flows in present value (PV) terms, assuming certain interest rate.

Using the average cost of similar road construction projects and the road project score 120-4, road insurance management system 130 may determine the estimated cost for potential claims. In one embodiment, the average road project score 120-4 for similar projects may be 20 out of 40, and only 10% of similar projects obtain a road project score of over 36 out of 40.

In one embodiment, road insurance management system 130 may assume a linear relationship between project claim costs and the road project score 120-4. That is, a road with a road project score of 40 out of 40 would have an estimated cost of claims of $0; a road with a road project score of 20 out of 40 would have an estimated cost of claims of $30 million; and a road with a road project score of 0 out of 40 would have an estimated cost of claims of $60 million. Road insurance management system 130 may then calculate the cost of claims in PV for highway A as follows: $60,000,000×(40×36)/40=$6,000,000. Other relationships between project claim costs and the road project score 120-4 may also be implemented by road insurance management system 130.

As shown in FIG. 2B, once the cost of potential claims is determined, road insurance management system 130 may determine an insurance policy premium amount based on the amount of insurance coverage requested, the probability that a claim against the insurance amount will occur and the cost of potential claims (step 270). An insurer may use a forecast developed by one or more actuarial processes giving the probability of future events for claims made by the insured entity. The insurer may use such forecasts in the calculation for insurance premiums and the necessary reserve.

Referring back to the road construction example including company A and highway A, the PV for the cost of potential claims for highway A may be $6,000,000. In one embodiment, assuming certain cost structures and interest rates, the insurer may require a gross return of 50% measured in PV terms on the investment, which may increase the cost to cover the potential claims for highway A to $9,000,000 in PV terms. The insurer may further decide that the premium would be paid in equal yearly amount in PV terms. That is, the present value of road construction company A's insurance premium may be $900,000 yearly. Because the calculated premium of $900,000 is in PV terms, the nominal amount will increase over time.

After the insurance policy premium is determined, road insurance management system 130 may further determine whether other insurance options should be considered (step 280). If no other insurance options are to be considered, road insurance management system may complete the insurance transaction process (step 290). On the other hand, if other insurance options are desirable, road insurance management system 130 may further analyze the insurance transaction, or obtain information from the insurer, to determine additional insurance according to various methods and structures (step 285). For example, the insurance transaction may include one or more insurance coverage amounts configured to be paid after the insurance coverage described above has been exhausted. The additional insurance coverage layers may include standard insurance premium payment structures. The additional insurance coverage may further include any type of insurance coverage structure; such as a captive insurance structure wherein the insurer is owned by insured entity.

After processing the additional insurance coverage, road insurance management system 130 may complete the insurance transaction process and generate an insurance policy. The insurance policy refers to a contract-between the insured entity and the insurer which defines the right and duties of the contracting parties. The policies may be maintained in various forms, such as a paper form and/or an electronic form. The insurance policy consistent with the present disclosure may also be structured to minimize moral hazard by setting appropriate deductibles or attachment point levels and by offering insurer a right to associate in the insured entity's related contractual or legal disputes and to participate in settlement negotiations.

### INDUSTRIAL APPLICABILITY

Methods and systems consistent with the disclosed embodiments enable insurers to underwrite road insurance policies to insured entities. In one embodiment, a road insurance management system may receive and store data related to road insurance transactions. A user may request the road insurance management system to generate a road insurance policy. The road insurance management system may assess and determine the design, build, and maintenance quality of a given road construction project. The road insurance management system may also monitor the road usage load and weather induced damages to the road. The road insurance management system may then determine the cost of potential claims for a given road construction project, and calculate the insurance premium accordingly. Additionally, the management system may generate an insurance policy based on data entered and collected by the users.

Methods and systems consistent with the disclosed embodiments may also,enable a user to use the road insurance management system to request price quotes for various insurance coverage levels. For example, a potential customer may request a first insurance coverage amount, and receive a first insurance premium quote from the road insurance management system. The potential customer may also request a second insurance coverage amount, receive a second insurance premium quote from the road insurance management system, and compare the first and second insurance premium quotes. Alternatively, road insurance management system may perform the computations and comparisons automatically and present the results to the user.

Methods and systems consistent with the disclosed embodiments may further be used as a business tool for insurers to test data records related to road construction projects, and various processes used for insurance underwriting. For example, an insurer may load different data files (e.g., actuarial tables, statistics, requirements, algorithms, etc.) into different instances of road insurance database, and use road insurance management system to calculate and compare insurance premiums based on varied data files and algorithms.

It will be apparent to those skilled in the art that various modifications and variations of the disclosed embodiments can be made. Additionally, other embodiments of the disclosed methods and systems will be apparent to those skilled in the art from consideration of the specification. It is intended that the specification and examples be considered as exemplary only, with a true scope of the disclosure being indicated by the following claims.

What is claimed is:

1. A method for providing road insurance, the method including:
requesting a first insurance coverage amount for a road;
determining, based on one or more design requirements, a design score for the road;
determining, based on one or more build requirements, a build score for the road;
determining a road project score based on the design score and the build score; and
determining a road insurance premium based on the first insurance coverage amount and the road project score.

2. The method of claim 1, further including:
determining, based on one or more maintenance requirements, a maintenance score for the road.

3. The method of claim 2, further including:
determining the road project score based on the design score, the build score, and the maintenance score.

4. The method of claim 2, further including:
determining, based on road usage, a road usage score for the road.

5. The method of claim 4, further including:
determining the road project score based on the design score, the build score, the maintenance score, and the road usage score.

6. The method of claim 5, further including:
requesting a second insurance coverage amount for the road.

7. The method of claim 1, further including:
generating one or more insurance policies based on the first insurance coverage amount, the road insurance premium, and the road project score.

8. A system for providing road insurance, the system including:
a server; and
a memory storing data including road construction project data, wherein the server is configured to:
receive a first insurance coverage amount request for a road;
determine, based on one or more design requirements, a design score for the road;
determine, based on one or more build requirements, a build score for the road;
determine a road project score based on the design score and the build score; and
determine a road insurance premium based on the first insurance coverage amount and the road project score.

9. The system of claim 8, the server is configured to:
determine, based on one or more maintenance requirements, a maintenance score for the road.

10. The system of claim 9, the server is further configured to:
determine the road project score based on the design score, the build score, and the maintenance score.

11. The system of claim 9, the server is further configured to:
determine, based on road usage, a road usage score for the road.

12. The system of claim 11, the server is further configured to:
determining the road project score based on the design score, the build score, the maintenance score, and the road usage score.

13. The system of claim 8, the server is further configured to:
receive a second insurance coverage amount request for the road.

14. The system of claim 8, the server is further configured to:
generate one or more insurance policies based on the first insurance coverage amount, the road insurance premium, and the road project score.

15. A computer-readable medium containing instructions to configure a processor to perform a method for generating a road insurance policy, the method including:
receiving a first insurance coverage amount request for a road;
determining, based on one or more design requirements, a design score for the road;
determining, based on one or more build requirements, a build score for the road;
determining a road project score based on the design score and the build score; and
determining a road insurance premium based on the first insurance coverage amount and the road project score.

16. The computer-readable medium of claim. 15, the method further including:
determining, based on one or more maintenance requirements, a maintenance score for the road.

17. The computer-readable medium of claim 16, the method further including:
determining the road project score based on the design score, the build score, and the maintenance score.

18. The computer-readable medium of claim 16, the method further including:
determining, based on road usage, a road usage score for the road.

19. The computer-readable medium of claim 18, the method further including:
determining the road project score based on the design score, the build score, the maintenance score, and the road usage score.

20. The computer-readable medium of claim 15, the method further including:
generating one or more insurance policies based on the first insurance coverage amount, the road insurance premium, and the road project score.
